(19) United States
(12) Patent Application Publication
(10) Pub. No.: US 2026/0279758 A1
(43) Pub. Date: Sep. 17, 2026

(54) ELECTRODE SHEET AND PREPARATION METHOD OF ELECTRODE SHEET

(71) Applicant: HUIZHOU LIWINON NEW ENERGY TECHNOLOGY CO., LTD., Huizhou (CN)

(72) Inventors: Chunlin HONG, Huizhou (CN); Biao FENG, Huizhou (CN); Cong LI, Huizhou (CN); Rongjin JI, Huizhou (CN); Jie CHEN, Huizhou (CN); Haibiao XIANG, Huizhou (CN)

(21) Appl. No.: 19/167,285

(22) PCT Filed: Nov. 13, 2023
(86) PCT No.: PCT/CN2023/131263

§ 371 Date: Sep. 19, 2025

(30) Foreign Application Priority Data
Oct. 25, 2023 (CN) 202311398465.2

(51) Int. Cl. H01M 4/04; H01M 4/139; H01M 10/42

(52) U.S. Cl. CPC H01M 4/0404; H01M 4/0435; H01M 4/139; H01M 10/4235

(57) ABSTRACT

The present disclosure relates to an electrode sheet and a preparation method of the electrode sheet. The electrode sheet comprises a current collector, a transition layer, and an active material layer. The transition layer is connected to the current collector, wherein a side of the transition layer facing away from the current collector is provided with a first groove. The active material layer is connected to the current collector, wherein the active material layer covers the transition layer, at least a portion of the active material layer is located in the first groove; and the active material layer is provided with a removal region, the removal region corresponds to the transition layer.

### CROSS-REFERENCE TO RELATED APPLICATION

This application is a national-stage application under 35 U.S.C. § 371 of international application number PCT/CN2023/131263, filed on Nov. 13, 2023, which claims priority to Chinese patent application No. 202311398465.2, filed on Oct. 25, 2023, whose contents are incorporated herein by reference in their entirety.

### TECHNICAL FIELD

The present disclosure relates to the technical field of battery preparation, and in particular to an electrode sheet and a preparation method of the electrode sheet.

### BACKGROUND

In the related art, a transition layer is pre-coated on the surface of the current collector before an active material is coated on the current collector, so as to improve the performance of the electrode sheet by using the transition layer. The coating of the active material layer will cover the transition layer and form certain protrusions at the position corresponding to the transition layer. In subsequent processes, a portion of the active material layer needs to be removed to expose the transition layer, ensuring that the performance of the transition layer is fully utilized. After removing part of the active material layer, some protrusions still exist on the surface of the active material layer. Moreover, these protrusions, along with the flat surface of the active material layer, exhibit a significant height difference relative to the height of the current collector. Meanwhile, the protrusions and the transition layer also exhibit a significant height difference relative to the current collector. Such significant height differences will increase the probability of wrinkling phenomenon of the electrode sheet during the subsequent rolling process. Therefore, it is necessary to conduct research to solve the problems mentioned above.

### SUMMARY

The present disclosure aims to solve at least one of the technical problems existing in the prior art. To this end, the present disclosure provides an electrode sheet that can reduce the probability of wrinkling phenomenon of the electrode sheet after completing the rolling process, thereby ensuring the yield rate of the electrode sheet.

The present disclosure also provides a method of preparing the aforementioned electrode sheet.

An electrode sheet according to an embodiment of the present disclosure comprises a current collector, a transition layer, and an active material layer, and the current collector has a predetermined thickness. The transition layer is connected to the current collector, and a first groove is provided on a side of the transition layer facing away from the current collector. The active material layer is connected to the current collector, and covers the transition layer. At least a portion of the active material layer is located in the first groove. The active material layer is provided with a removal region corresponding to the transition layer.

The electrode sheet according to the embodiment of the present disclosure has at least the following beneficial effects: by providing the first groove on the side of the transition layer facing away from the current collector, a compensation space can be provided in the thickness direction of the current collector, allowing a portion of the active material layer to fill into the first groove, thereby reducing the protrusion height formed on the surface of the active material layer. Consequently, after removing a portion of the active material layer in the removal region, the height difference formed by the protrusion is reduced, thereby effectively reducing the probability of wrinkling phenomenon of the electrode sheet after completing the rolling process to ensure the yield rate of the electrode sheet.

According to some embodiments of the present disclosure, the current collector has a predetermined length, and the first groove and the removal region are arranged in a staggered manner in the length direction.

According to some embodiments of the present disclosure, a projection of the removal region along the thickness direction onto an end face of the transition layer is located on an inner side of the end face of the transition layer in the length direction, and the first groove is located at an outer edge of the transition layer in a direction perpendicular to the thickness direction of the current collector.

According to some embodiments of the present disclosure, the current collector has a predetermined width, and the first grooves are provided on outer edges of the transition layer in both the length direction and the width direction.

According to some embodiments of the present disclosure, the side of the transition layer facing away from the current collector has a first end face and a second end face; the first end face is an end face on the side of the transition layer facing away from the current collector, which has the largest distance from the current collector; a distance between the first end face and the current collector is L1; the second end face is a bottom surface of the first groove facing the current collector; and a distance between the second end face and the current collector is L2, and 2 μm≤L1-L2≤20 μm.

According to some embodiments of the present disclosure, the transition layer is a ceramic layer.

According to some embodiments of the present disclosure, a second groove is provided on a side of the active material layer facing away from the current collector; the second groove corresponds to the removal region, and communicates with a surface of a side of the transition layer facing away from the current collector.

A method of preparing an electrode sheet according to an embodiment of the present disclosure, for use in preparing the electrode sheet described in the aforementioned embodiments, comprising the following steps of:
applying a coating material of the transition layer on a side of the current collector to form the transition layer;
removing a portion of a side of the transition layer facing away from the current collector to form a first groove;
applying a coating material of the active material layer on the current collector, such that at least a portion of the coating material of the active material layer covers the transition layer to form an active material layer.

The method of preparing the electrode sheet according to the embodiment of the present disclosure has at least the following beneficial effects: by removing a portion of the transition layer to form the first groove, a portion of the active material layer can be located in the first groove after the coating material of the active material layer is applied and formed. The first groove can provide compensation space to reduce the protrusion height of the active material layer brought by the presence of the transition layer, thereby reducing the probability of wrinkling phenomenon of the electrode sheet after completing the subsequent rolling process to ensure the yield rate of the electrode sheet.

According to some embodiments of the present disclosure, after forming the active material layer, the method further comprises the following step of: removing a portion of a side of the active material layer facing away from the current collector to form a second groove that exposes the transition layer.

According to some embodiments of the present disclosure, after forming the active material layer, the method further comprises the following steps of: removing a portion of the side of the active material layer facing away from the current collector; and removing a portion of the side of the transition layer facing away from the current collector, wherein a second groove is defined between the active material layer and the transition layer, and exposes the transition layer.

According to some embodiments of the present disclosure, after forming the second groove, the method further comprises the following step of: performing rolling on the current collector, the active material layer, and the transition layer.

Additional aspects and advantages of the present disclosure would be set forth in part in the following description, and would partially become apparent from the following description, or to be understood through the practice of the present disclosure.

### BRIEF DESCRIPTION OF DRAWINGS

The present disclosure will be further described below in conjunction with the accompanying drawings and embodiments, in which:

FIG. 1 is a schematic diagram of the electrode sheet according to an embodiment of the present disclosure;

FIG. 2 is a cross-sectional view of the electrode sheet according to an embodiment of the present disclosure;

FIG. 3 is a cross-sectional view of the electrode sheet according to some other embodiments of the present disclosure;

FIG. 4 is a partial schematic diagram of the electrode sheet according to an embodiment of the present disclosure;

FIG. 5 is a schematic diagram of the electrode sheet according to an embodiment of the related art;

FIG. 6 is a cross-sectional view of the electrode sheet according to an embodiment of the related art;

FIG. 7 is a cross-sectional view of the electrode sheet according to some other embodiments of the related art;

FIG. 8 is a cross-sectional view of the electrode sheet according to some other embodiments of the related art;

FIG. 9 is a flowchart of the method of preparing the electrode sheet according to some embodiments of the present disclosure;

FIG. 10 is a flowchart of the method of preparing the electrode sheet according to some other embodiments of the present disclosure; and

FIG. 11 is a flowchart of the method of preparing the electrode sheet according to some other embodiments of the present disclosure.

### REFERENCE SIGNS

current collector 100, transition layer 200, first groove 201, first end face 210, second end face 220, active material layer 300, second groove 310, removal region 320;
current collector 400, transition layer 410, active material layer 420, protrusion 421, wrinkle 430.

### DETAILED DESCRIPTION

The embodiments of the present disclosure are described in detail below, with examples of the embodiments illustrated in the accompanying drawings. Throughout the drawings, the same or similar reference numerals denote the same or similar elements or elements having the same or similar functions. The embodiments described below with reference to the accompanying drawings are exemplary and are merely used to explain the present disclosure, and should not be construed as limiting the disclosure.

In the description of the present disclosure, it should be understood that descriptions involving orientations, such as orientations or positional relationships indicated by up, down, front, rear, left, right, etc. refer to the orientations or positional relationships based on those shown in the accompanying drawings. These descriptions are merely for convenience in describing the present disclosure and simplifying the description, instead of indicating or implying that the apparatus or elements referred must have a specific orientation or be constructed and operated in a specific orientation. Thus, they cannot be construed as limiting the disclosure. If “first” and “second” are described, they are only used for the purpose of distinguishing the technical features, and cannot be interpreted as indicating or implying relative importance, or implicitly specifying the number of the indicated technical features, or implicitly specifying the order of the indicated technical features.

In the description of the present disclosure, unless otherwise explicitly defined, terms such as providing, installing, and connecting should be understood in a broad sense. Those skilled in the art can reasonably determine the specific meanings of the above terms in the present disclosure based on the specific content of the technical solution.

In the description of the present disclosure, reference to terms such as “one embodiment”, “some embodiments”, “illustrative embodiment”, “example”, “specific example”, or “some examples” mean that the specific features, structures, materials, or characteristics described in conjunction with the embodiment or example are included in at least one embodiment or example of the present disclosure. In the present specification, schematic references to the above terms do not necessarily refer to the same embodiment or example. Furthermore, the specific features, structures, materials, or characteristics as described may be combined in any suitable manner in any one or more embodiments or examples.

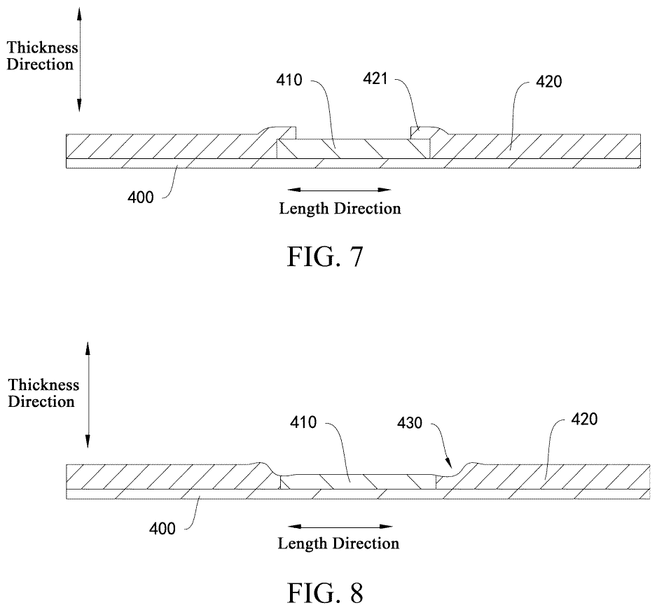

Referring to FIG. 6 to FIG. 8, FIG. 6 showed an electrode sheet in the related art in a state where the active material layer was not removed. FIG. 7 showed an electrode sheet in which a portion of the active material layer was removed to expose the transition layer, in the basis of the electrode sheet of FIG. 6. FIG. 8 showed an electrode sheet after rolling, in the basis of the electrode sheet of FIG. 7. In the related art, after the active material layer 420 was applied on the current collector 400; the protrusion 421 on a side facing away from the current collector 400 was formed on the active material layer 420 at a position corresponding to the transition layer 410. After a portion of the active material layer 420 was removed to expose the transition layer 410, there was a height difference between the protrusion 421 and the flat surface of the active material layer 420 relative to the current collector 400; there was also a height difference between the protrusion 421 and the transition layer 410 relative to the current collector 400. Due to the presence of the protrusion 421, after rolling was performed, the electrode sheet exhibited a wrinkling phenomenon as shown in FIG. 8 to form the wrinkle 430, which affected the flatness of the electrode sheet and thus affected the performance of the electrode sheet. In order to solve the above problem, the present disclosure provided a first groove on the transition layer; and the first groove provided a compensation space in the thickness direction to reduce the protruding height of the protrusion and the resulting height difference, thereby reducing the probability of wrinkling phenomenon after rolling process, and improving the flatness of the electrode sheet after rolling.

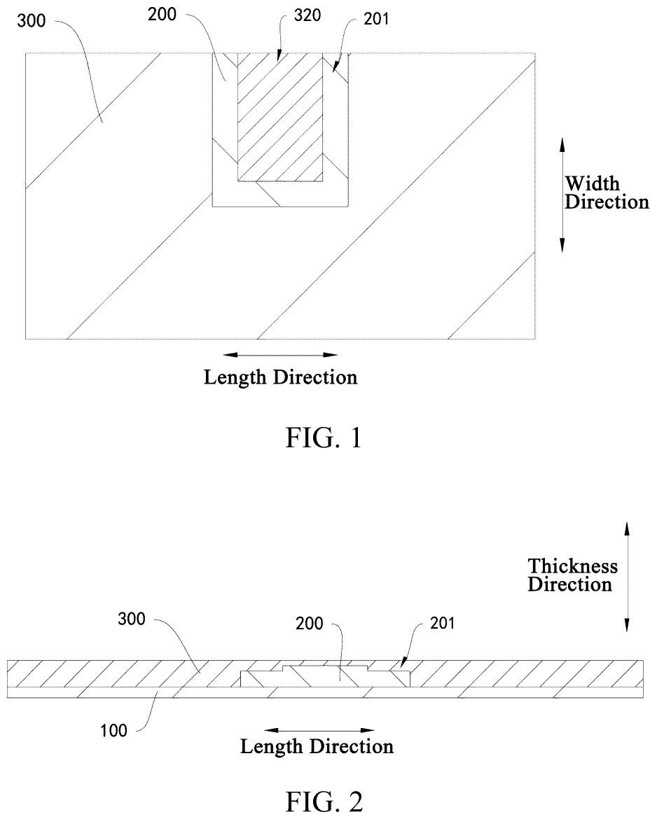

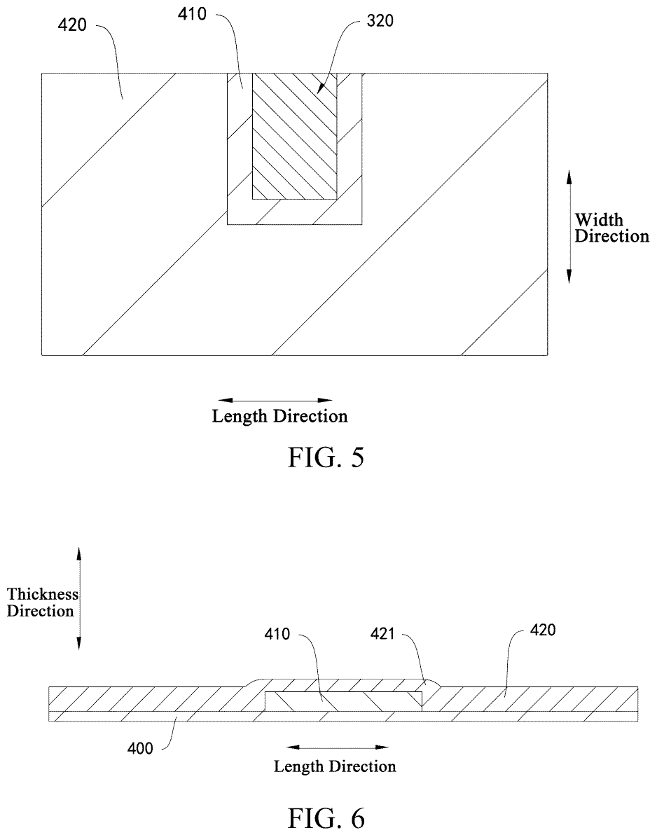

The electrode sheet of the embodiments of the present disclosure was described below with reference to the drawings. It should be noted that the active material layer 300 was not removed in both FIG. 1 and FIG. 5, and the projection areas of the transition layer 200 and the removal region 320 along the thickness direction were presented by hatching for illustration purpose. FIG. 4 only showed a portion of the transition layer 200 and the current collector 100. Although not explicitly shown in FIG. 2 to FIG. 4, there were protrusions having a relatively small amplitude. For the sake of convenience, it was not emphasized in the figures here. The specific position and shape of the protrusions could be referred to in FIG. 6 and FIG. 7.

Referring to FIG. 1 to FIG. 4, the electrode sheet according to the embodiments of the present disclosure included the current collector 100, the transition layer 200, and an active material layer 300. The current collector 100 had a predetermined thickness. The transition layer 200 was connected to the current collector 100, and the first groove 201 was provided on a side of the transition layer 200 facing away from the current collector 100. The active material layer 300 was connected to the current collector 100 and covered the transition layer 200. At least a portion of the active material layer 300 was located in the first groove 201. The active material layer 300 was provided with the removal region 320 corresponding to the transition layer 200. By providing the first groove 201 on the side of the transition layer 200 facing away from the current collector 100, a compensation space could be provided in the thickness direction of the current collector 100, allowing a portion of the active material layer 300 to fill into the first groove 201, thereby reducing the protrusion height formed on the surface of the active material layer 300. Consequently, after a portion of the active material layer 300 in the removal region 320 was removed, the height difference formed by the protrusion was reduced, thereby effectively reducing the probability of wrinkling phenomenon of the electrode sheet after completing the rolling process to ensure the yield rate of the electrode sheet.

The transition layer 200 could reduce the probability of fire or heat generation when the battery was subjected to abnormal conditions such as squeezing, collision or nail penetration, and better protected the current collector 100 to reduce short circuit and runaway problems caused by exposed edges of fractures in the current collector 100, thereby improving the safety of the battery. The transition layer 200 could be a layer comprising nickel-cobalt-manganese ternary material particles or lithium iron phosphate particles. By utilizing the properties of the nickel-cobalt-manganese ternary material particles and the lithium iron phosphate particles, the probabilities of lessening energy density and decreasing cycling performance of the battery could be reduced, so as to ensure the performance of the battery. In some embodiments, the transition layer 200 was a ceramic layer containing ceramic particles. The ceramic particles were capable of reducing the probability of lithium plating during low-temperature charging of the battery, thereby slowing down the capacity decay rate of the battery and improving the safety of the battery. Meanwhile, the ceramic layer could further increase the adhesion between the active material layer 300 and the current collector 100, reduce the expansion amplitude of the electrode sheet during cycling, ensure the electrical performance of the battery, and extend the service life of the battery.

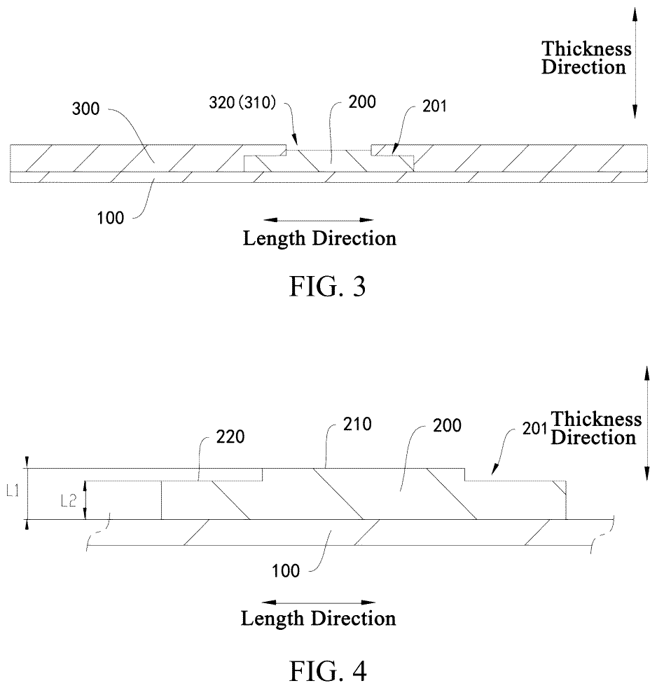

Referring to FIG. 2 and FIG. 3, in some embodiments, the second groove 310 was provided on a side of the active material layer 300 facing away from the current collector 100. The second groove 310 corresponded to the removal region 320 and communicated with a surface of a side of the transition layer 200 facing away from the current collector 100. The second groove 310 was formed by removing a portion of the active material layer 300 in the removal region 320, which could reduce a portion of the active material layer 300, so that when the electrode sheet was used as a cathode sheet, the probability of lithium plating could be reduced. Moreover, by exposing the transition layer 200 through the second groove 310 and corresponding the transition layer 200 to the tab, the probability of structures such as burrs on the tab piercing the surface of the electrode sheet and directly contacting the current collector 100 was effectively reduced, thereby improving the safety performance of the electrode sheet.

Referring to FIG. 1 and FIG. 3, the removal region 320 provided on the active material layer 300 was located in the region where the protrusion was formed after the active material layer 300 was applied on the transition layer 200. In some embodiments, the projection of the removal region 320 in the thickness direction was located within the end face of the transition layer 200, i.e., the projection of the second groove 310 in the thickness direction was located within the end face of the transition layer 200, so as to ensure that the transition layer 200 could be accurately exposed after a portion of the active material layer 300 was removed, and that the transition layer 200 could be accurately positioned when used to correspond to the tab.

After a portion of the active material layer 300 in the removal region 320 was removed, referring to FIG. 3, unremoved protrusion was present in the portion of the active material layer 300 that was not covered by the projection of the second groove 310 in the transition layer 200. In some embodiments, referring to FIG. 3 and FIG. 4, the first groove 201 and the removal region 320 were staggered in the length direction of the current collector 100, so as to ensure that the position of the space compensation provided by the first groove 201 directly corresponded to the unremoved protrusion, thereby minimizing the protrusion height formed on the surface of the active material layer 300 and the height difference relative to the transition layer 200, so as to further ensure the flatness of the electrode sheet surface after subsequent rolling operation and reduce the probability of wrinkling phenomenon.

Furthermore, referring to FIG. 1 and FIG. 3, the projection of the removal region 320 along the thickness direction onto the end face of the transition layer 200 was located on an inner side of the end face of the transition layer 200 in the length direction of the current collector 100, which ensured that after a portion of the active material layer 300 was removed, the second groove 310 formed completely corresponded to the transition layer 200. In addition, the first groove 210 was located at an outer edge of the transition layer 200 in a direction perpendicular to the thickness direction of the current collector 100, so as to ensure the space compensation effect provided by the first groove 201. In further embodiments, the first groove 201 was provided at the outer edges of the transition layer 200 in both the length and width directions of the current collector 100, which ensured that after a portion of the active material layer 300 was removed, the second groove 310 was surrounded, so as to ensure that the protrusions formed around the periphery of the second groove 310 obtained space compensation, thereby improving uniformity and further reducing the probability of subsequent wrinkling phenomenon. Specifically, the first groove 201 could extend along the circumference of the transition layer 200 to form a U-shaped groove, so as to achieve a semi-enclosure of the removal region 320. Alternatively, the first grooves 201 distributed in the length and width directions were combined into an L-shaped groove.

The occurrence of the wrinkling phenomenon was closely related to the protrusion height of the active material layer 300 and the resulting height difference. Based on this, as another aspect of improvement of the aforementioned solution, referring to FIG. 4, the side of the transition layer 200 facing away from the current collector 100 had a first end face 210 and a second end face 220. The first end face 210 was an end face on the side of the transition layer 200 facing away from the current collector 100 that had the largest distance from the current collector 100; a distance between the first end face 210 and the current collector 100 was L1; the second end face 220 was a bottom surface of the first groove 201 facing the current collector 100; and a distance between the second end face 220 and the current collector 100 was L2, and 2 μm≤L1-L2≤20 μm. By controlling the difference between L1 and L2, the depth of the first groove 201 in the thickness direction could be controlled, thereby adjusting the space compensation effect. If L1-L2 was less than 2 μm, the depth of the first groove 201 was small, and the provided space compensation was insufficient. 2 μm≤L1-L2 guaranteed sufficient depth for space compensation. If L1-L2 was greater than 20 μm, the transition layer 200 was required to have a significantly greater thickness. The thickness of the transition layer 200 could even be greater than the predetermined thickness of the active material layer 300, which would affect the use of the electrode sheet. Furthermore, a greater thickness of the active material layer 300 in the removal region 320 was required to be removed, which could easily lead to over-removal and exposure of the current collector 100, resulting in a high defect rate and a high process requirement. Therefore, by maintaining L1-L2 within the range of 2 μm to 20 μm achieved good space compensation effect while facilitating the preparation of the transition layer 200.

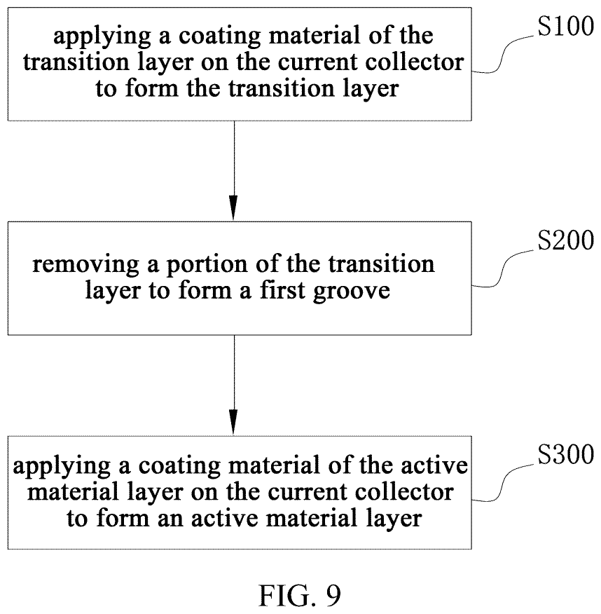

Referring to FIG. 9, the method of preparing the electrode sheet according to the embodiments of the present disclosure, for use in preparing the electrode sheet described in the aforementioned embodiments, included the following steps of:
S100: a coating material of the transition layer was applied on a side of the current collector 100 to form the transition layer 200;
S200: a portion of a side of the transition layer 200 facing away from the current collector 100 was removed to form a first groove 201;
S300: a coating material of the active material layer was applied on the current collector 100, such that at least a portion of the coating material of the active material layer covered the transition layer 200 to form an active material layer 300.

By performing step S200 to remove a portion of the transition layer 200 to form the first groove 201, a portion of the active material layer 300 could be located in the first groove 201 after the coating material of the active material layer 300 was applied and formed in step S300. The first groove 201 was capable of providing a compensation space to reduce the protrusion height of the active material layer 300 brought by the presence of the transition layer 200, thereby reducing the probability of wrinkling phenomenon of the electrode sheet after completing the subsequent rolling process to ensure the yield rate of the electrode sheet.

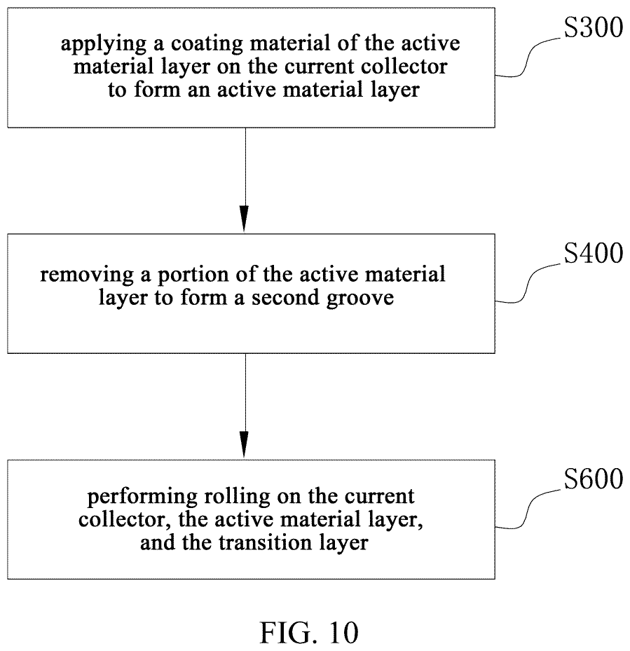

Referring to FIG. 10, in some embodiments, after the active material layer 300 was formed, the method further included the following step of: S400: a portion of the side of the active material layer 300 facing away from the current collector 100 was removed to form a second groove 310 which exposed the transition layer 200. In step S500, a portion of the active material layer 300 was removed to form a second groove 310, so that the exposure of the transition layer 200 could be realized.

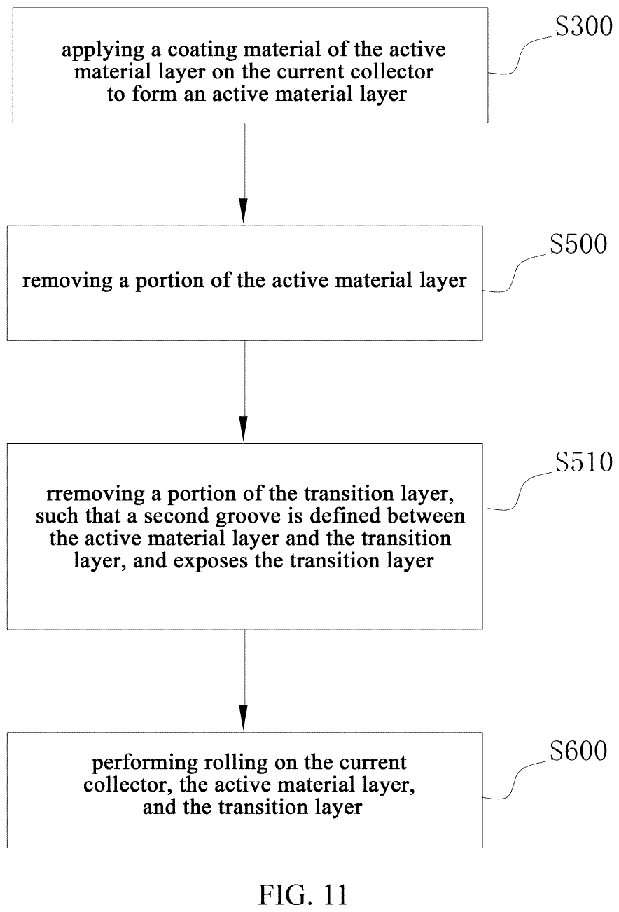

Referring to FIG. 11, in some other embodiments, after the active material layer 300 was formed, the method further included the following steps of: S500: a portion of the side of the active material layer 300 facing away from the current collector 100 was removed. S510: a portion of the side of the transition layer 200 facing away from the current collector 100 was removed; the second groove 310 was defined between the active material layer 300 and the transition layer 200, and exposed the transition layer 200. On the basis of removing a portion of the active material layer 300 in step S510, a portion of the transition layer 200 facing away from the current collector 100 was removed to form the second groove 310 in step S520, so that after the active material layer 300 was formed, the maximum thickness of the transition layer 200 was reduced, thereby reducing the depth of the first groove 201 at this stage and making the transition layer 200 flatter as a whole, which further improved the uniformity of the surface of the active material layer 300 during subsequent rolling process.

When removing the active material layer 300 and the transition layer 200, methods such as laser removal, or conventional removal methods in the art, such as manual scraping and mechanical scraping, could be adopted for removal.

After the second groove 310 was formed, the method further included the following step of: S600: rolling on the current collector 100, the active material layer 300, and the transition layer 200 was performed. By performing the rolling operation in step S600, the current collector 100, the active material layer 300, and the transition layer 200 were compacted to improve the performance of the electrode sheet.

The embodiments of the present disclosure are described in detail as above with reference to the accompanying drawings. However, the present disclosure is not limited to the above embodiments. Various changes can be made within the knowledge of those ordinary skilled in the art without departing from the spirit of the present disclosure. Furthermore, the embodiments of the present disclosure and the features of the embodiments may be combined with each other without any conflict.

1. An electrode sheet, comprising:
a current collector having a predetermined thickness;
a transition layer connected to the current collector, wherein a side of the transition layer facing away from the current collector is provided with a first groove; and
an active material layer connected to the current collector, wherein the active material layer covers the transition layer, at least a portion of the active material layer is located in the first groove;
and the active material layer is provided with a removal region, the removal region corresponds to the transition layer.

2. The electrode sheet according to claim 1, wherein the current collector has a predetermined length, and the first groove and the removal region are arranged in a staggered manner in the length direction.

3. The electrode sheet according to claim 2, wherein a projection of the removal region along the thickness direction onto an end face of the transition layer is located on an inner side of the end face of the transition layer in the length direction; and the first groove is located at an outer edge of the transition layer in a direction perpendicular to the thickness direction of the current collector.

4. The electrode sheet according to claim 3, wherein the current collector has a predetermined width, and outer edges of the transition layer in both the length direction and the width direction are provided with the first grooves.

5. The electrode sheet according to claim 1, wherein the side of the transition layer facing away from the current collector has a first end face and a second end face; the first end face is an end face on the side of the transition layer facing away from the current collector, which has the largest distance from the current collector; a distance between the first end face and the current collector is L1; the second end face is a bottom surface of the first groove facing the current collector; and a distance between the second end face and the current collector is L2, and 2 μm≤L1-L2≤20 μm.

6. The electrode sheet according to claim 1, wherein the transition layer is a ceramic layer.

7. The electrode sheet according to claim 1, wherein a side of the active material layer facing away from the current collector is provided with a second groove; the second groove corresponds to the removal region, and the second groove communicates with a surface of the side of the transition layer facing away from the current collector.

8. A preparation method of the electrode sheet according to claim 1, comprising the following steps of:
applying a coating material of the transition layer on a side of the current collector to form the transition layer;
removing a portion of a side of the transition layer facing away from the current collector to form a first groove;
applying a coating material of the active material layer on the current collector, such that at least a portion of the coating material of the active material layer covers the transition layer to form an active material layer.

9. The preparation method of the electrode sheet according to claim 8, wherein, after forming the active material layer, the preparation method further comprises the following step of:
removing a portion of a side of the active material layer facing away from the current collector to form a second groove that exposes the transition layer.

10. The preparation method of the electrode sheet according to claim 8, wherein after forming the active material layer, the preparation method further comprises the following steps of:
removing a portion of the side of the active material layer facing away from the current collector;
removing a portion of the side of the transition layer facing away from the current collector,
wherein a second groove is defined between the active material layer and the transition layer, and exposes the transition layer.

11. The preparation method of the electrode sheet according to claim 9, wherein after forming the second groove, the preparation method further comprises the following step of: performing rolling on the current collector, the active material layer, and the transition layer.

12. The electrode sheet according to claim 2, wherein a side of the active material layer facing away from the current collector is provided with a second groove; the second groove corresponds to the removal region, and the second groove communicates with a surface of the side of the transition layer facing away from the current collector.

13. The electrode sheet according to claim 3, wherein a side of the active material layer facing away from the current collector is provided with a second groove; the second groove corresponds to the removal region, and the second groove communicates with a surface of the side of the transition layer facing away from the current collector.

14. The electrode sheet according to claim 4, wherein a side of the active material layer facing away from the current collector is provided with a second groove; the second groove corresponds to the removal region, and the second groove communicates with a surface of the side of the transition layer facing away from the current collector.

15. The electrode sheet according to claim 5, wherein a side of the active material layer facing away from the current collector is provided with a second groove; the second groove corresponds to the removal region, and the second groove communicates with a surface of the side of the transition layer facing away from the current collector.

16. The electrode sheet according to claim 6, wherein a side of the active material layer facing away from the current collector is provided with a second groove; the second groove corresponds to the removal region, and the second groove communicates with a surface of the side of the transition layer facing away from the current collector.

17. The preparation method of the electrode sheet according to claim 10, wherein after forming the second groove, the preparation method further comprises the following step of:
performing rolling on the current collector, the active material layer, and the transition layer.
